(19) United States
(12) Patent Application Publication
(10) Pub. No.: US 2023/0392574 A1
(43) Pub. Date: Dec. 7, 2023

(54) UNDERWATER POWER PLANT COMPRISING ASYMMETRIC FOILS

(71) Applicant: TIDAL SAILS AS, HAUGESUND (NO)

(72) Inventor: Are Borgesen, Haugesund (NO)

(73) Assignee: TIDAL SAILS AS, HAUGESUND (NO)

(21) Appl. No.: 18/249,915

(22) PCT Filed: Oct. 18, 2021
(86) PCT No.: PCT/NO2021/050216

§ 371 Date: Apr. 20, 2023

(30) Foreign Application Priority Data
Oct. 20, 2020 (NO) 20201132

(51) Int. Cl. F03B 17/06; F03B 13/22

(52) U.S. Cl. CPC F03B 17/066; F03B 13/22; F05B 2250/73; F05B 2270/1011

(57) ABSTRACT

An underwater power plant for arrangement in a water current includes at least two rotatable stations and at least one endless traction member connected to the rotatable stations. The at least one endless traction member is configured to rotate the at least two rotatable stations as the endless traction member moves in its lengthwise direction. At least one asymmetric foil is connected to the at least one endless traction member and configured to move the endless traction member in its lengthwise direction as the water current impacts the asymmetric foil. The at least one asymmetric foil has an upper camber side and a lower camber side. The upper camber side is facing in a direction outwards of the at least one endless traction member and the lower camber side is facing in a direction inwards of the at least one endless traction member.

### CROSS REFERENCE TO RELATED APPLICATIONS

The present application claims the priority benefits of International Patent Application No. PCT/NO2021/050216, filed on Oct. 18, 2021, and claims benefit of NO 20201132, filed on Oct. 20, 2020, which are hereby incorporated herein by reference in their entireties.

### FIELD OF THE INVENTION

The present invention relates to an underwater power plant. More specifically, the disclosure relates to an underwater power plant having asymmetric foils for extracting energy from water currents such as river flows and tidal currents.

### BACKGROUND OF THE INVENTION

Documents useful for understanding the field of technology include WO 2013/043057 A1 which describes a self-adjusting foil suspension system in which a symmetric foil is placed in a fluid flow, typically a tidal flow, and in which the foil is rotatable around a rotational axis, and in which the foil is connected by means of an arm to a track. The arm is rotatable around a rotational axis and rotatably connected to the track around a suspension axis at a radial distance from the rotational axis, and the suspension axis is parallel to the rotational axis.

GB 2 131 491 A describes a device having a series of aerofoils or airfoils mounted on one or more endless belts running around two or more fixed pivot points placed some distance apart and providing the sole support for the belts. Power can be extracted from either the motion of the belts, or the rotary motion at one or more of the pivot points. The aerofoils are symmetric (or nearly so), and placed with their chords substantially parallel to the direction of travel of the belt.

WO2016/126166 A1 describes a plant and a method for exploiting the energy of a water current. The energy plant which is placed in the water current, includes at least one rope extending around at least two turning stations and carry at least one at least partially submerged foil which is approximately symmetrical around its chord. The velocity and direction of flow of the water together with the moving speed and direction of the foil giving a resulting water velocity and direction acting on the foil. The method includes pivoting the foil until it has a desired angle of attack to the resulting water direction when the foil is being displaced co-currently; and pivoting the foil until it has a desired angle of attack to the resulting water direction when the foil is being displaced counter-currently, the angle of attack being the same or different co-currently and counter-currently.

Other documents useful for understanding the field of technology include EP 2685089 A and WO 2006028454 A.

The prior art also includes US 2009096215 A1, FR 2689184 A1, FR 2474106 A1, and JP 557151074 A, which all describe underwater power plants that are arranged generally aligned with the prevailing water current.

There is therefore a need for an improved underwater power plant. For example, there is a need for an improved underwater power plant that has a simpler and improved overall construction and that is more effective in harvesting energy when compared to the underwater power plants known in the art.

### SUMMARY OF THE INVENTION

Aspects of the present invention provide un underwater power plant that has a simpler and improved overall construction when compared to the underwater power plants known in the art. Moreover, the underwater power plant of the present disclosure is much more effective in harvesting energy from water currents when compared to the underwater power plants known in the art.

According to one aspect of the invention, there is provided an underwater power plant for arrangement in a water current. The underwater power plant includes at least two rotatable stations; at least one endless traction member connected to the rotatable stations, the at least one endless traction member configured to rotate the at least two rotatable stations as the endless traction member moves in its lengthwise direction; and at least one asymmetric foil connected to the at least one endless traction member and comprising an upper camber side and lower camber side.

The at least one asymmetric foil is configured to move the endless traction member in its lengthwise direction as the water current impacts the asymmetric foil. The upper camber side of at least one foil is facing in a direction outwards of the at least one endless traction member and the lower camber side of at least one foil is facing in a direction inwards of the at least one endless traction member. The power plant is oriented so as to define a downstream leg and an upstream leg with respect to the water current for the at least one traction member. The lower camber side on the downstream leg is facing the water current, and the upper camber side on the upstream leg is facing the water current.

According to an embodiment, the upper camber side has a low pressure profile, and the lower camber side has a high pressure profile. According to an embodiment, the at least one asymmetric foil is stiff.

According to an embodiment, the endless traction member comprises a rope or other elongated and flexible member, such as a wire, chain or belt.

According to an embodiment, the endless traction member is rotatably supported by rotatable sheaves connected to the rotatable stations.

According to an embodiment, at least one rotatable station comprises a generator and rotatable transmission means whereby the generator may generate electrical energy when the endless traction member is moving.

According to an embodiment, where the power plant further comprises a connection device for rotatably connecting the at least one asymmetric foil to the at least one endless traction member.

According to an embodiment, the foil further comprises a connection member for connecting the foil to the connection device.

According to an embodiment, a damper element is arranged to restrict rotation of the foil about an axis parallel with the span of the foil. According to an embodiment, the damper element is a spring.

According to an embodiment, rotation of the foil is restricted by a free lateral travel sector to either side of the endless traction member.

According to an embodiment, at least one foil is configured to be released from the damper element at a first rotatable station thereby allowing the at least one foil to freely rotate about the connection member.

According to an embodiment, the at least one foil is configured to be connected to the damper element at a second rotatable station.

The present invention will become apparent from the detailed description given below. The detailed description and specific examples disclose preferred embodiments of the invention by way of illustration only. Those skilled in the art understand from guidance in the detailed description that changes and modifications may be made within the scope of the invention.

Hence, it is to be understood that the herein disclosed invention is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an” and “the” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

These and other objects, advantages and features of the invention will become apparent upon review of the following specification in conjunction with the drawings.

### BRIEF DESCRIPTION OF THE DRAWINGS

The above objects, as well as additional objects, features and advantages of the present invention, will be more fully appreciated by reference to the following illustrative and non-limiting detailed description of example embodiments of the present invention, when taken in conjunction with the accompanying figures.

FIG. 1 shows a plan view of an embodiment of an underwater power plant arranged in a body of water;

FIG. 2 shows a side view of a portion of the underwater power plant;

FIG. 3 shows a sectional view of an asymmetric foil;

FIG. 4 shows an enlarged view of the box “A” in FIG. 1, illustrating forces generated by an asymmetric foil being subjected to water currents;

FIGS. 5a and 5b show a perspective view and a side view of an embodiment of a foil provided with upper and lower connection devices; and

FIG. 6 corresponds to FIG. 1, but shows the underwater power plant in a configuration in which some foils have been released such that they are free to rotate about the connection member relative to the endless traction members.

### DESCRIPTION OF THE PREFERRED EMBODIMENTS

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

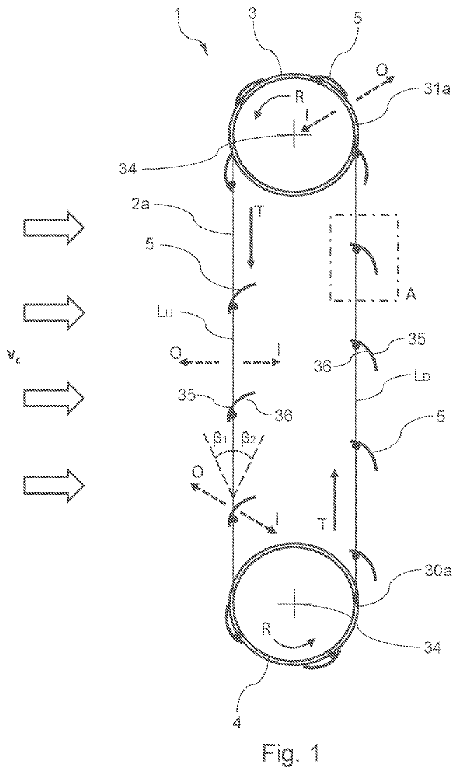

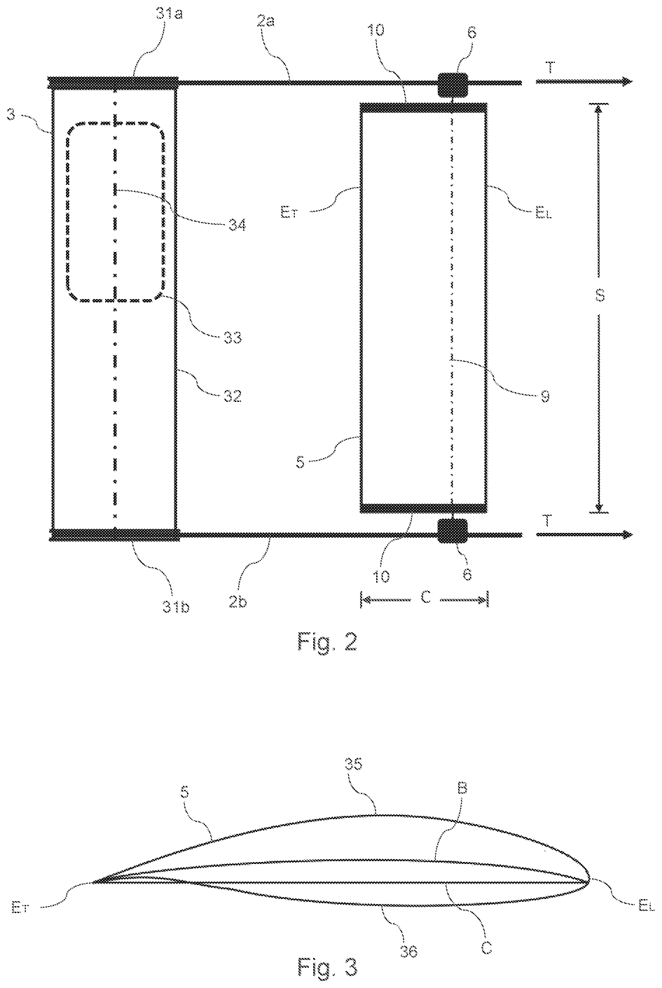

Referring to FIGS. 1 and 2, the underwater power plant 1 comprises in the illustrated embodiment two rotatable stations 3,4, connected by two endless traction members 2a,b, here in the form of upper and lower endless ropes 2a,b. The two rotatable stations 3,4 are configured for rotation in a direction R, indicated in FIG. 1. The endless traction members 2a,b may as such be drive members configured to transfer a longitudinal movement of the endless traction members 2a,b to the rotatable stations 3,4. In FIG. 2, only one rotatable station 3 is visible, and in FIG. 1 only the upper endless traction member 2a is visible.

The upper endless traction member 2a may be rotatably supported by corresponding upper rotatable sheaves 30a, 31a on each rotatable station (upper sheave 31a illustrated in FIG. 2) and a lower endless traction member 2b may be rotatably supported by corresponding lower rotatable sheaves on each rotatable station (lower sheave 31b illustrated in FIG. 2). The rotatable sheaves 30a,b, 31a,b may be fixed to the corresponding rotatable stations 3,4 such that when the moving endless traction members 2a,b interacts with the sheaves 30a,b, 31a,b, the sheaves and the rotatable stations 3,4 rotate.

In another embodiment, the sheaves 30a,b, 31a,b may be part of the rotatable stations 3,4. Alternatively, the rotatable sheaves 30a,b, 31a,b may be mechanically coupled to the rotatable stations 3,4, such that when the endless traction members 2a,b interact with the sheaves 30a,b, 31a,b, the sheaves and the rotatable stations 3,4 rotate. The rotation speed of the rotatable stations 3,4 may as such differ from the rotation speed of the rotatable sheaves 30a,b, 31a,b. The invention shall not be limited to this number of endless traction members; systems having fewer or more endless traction members are conceivable. It should be understood that the endless traction members 2a,b may comprise elongated and flexible members such as wires, chains, synthetic fibre ropes, or belts.

At least one of the rotatable stations 3,4 is a generator station for generating electrical energy, in which one or more of the sheaves 30a,b, 31a,b may be connected to an electrical current generator 33 via a generator shaft 34. In the case that only one rotatable station comprises a generator, the other rotatable station is merely a rotatable support for the endless traction members 2a,b.

The generator 33 and generator shaft 34 may be arranged inside a housing 32. Each station 3,4 may be furnished with buoyancy means (not shown) and may be connected to fixed structures by means of synthetic ropes, chains, etc. (not shown), or any other mooring means or support means known in the art of mooring underwater stations. It will be readily understood that movement of the endless traction members 2a,b will cause the sheaves 31a,b, 30a,b and shaft 34 to rotate. This rotational movement is transferred to the generator 33, whereby electrical energy is generated. Such generation of electrical energy is well known in the art and need therefore not be described further.

In the embodiment illustrated in FIG. 1, the sheaves 30a, 31a (30b, 31b not visible) and endless traction members 2a (2b not visible) rotate counter-clockwise in the direction R. With respect to a water current v_{c}, a first leg between the rotatable stations 3,4 is a downstream leg L_{D} and a second leg between the rotatable stations 3,4 is an upstream leg L_{U}. By virtue of the plant's transverse orientation with respect to the water current v_{c}, in the illustrated embodiment of FIG. 1, the downstream leg L_{D} is in effect a port beam reach leg and the upstream leg L_{U} is in effect a starboard beam reach leg. It should be noted that the invention shall not be limited to the orientation shown in FIG. 1.

Asymmetric foils 5 are connected at intervals to the endless traction members 2a,b, each such foil 5 having a span S and a cord line C. The underwater power plant may comprise only one foil 5, but preferably a plurality. A plurality of foils 5 provides a constant movement of the endless traction members 2a,b. Each asymmetric foil 5 may optionally be fitted with winglets 10 at each end. If arranged on two or more endless traction members 2a,b, each foil 5 may be arranged on the endless traction members 2a,b such that the endless traction members 2a,b are displaced in parallel in a direction along the span S of the foil 5.

Referring additionally to FIG. 3, an asymmetric foil 5 shall for the purpose of this invention be understood as a foil having a leading edge E_{L}, a trailing edge E_{T}, and a distance (camber) greater than zero between a chord line C and a camber mean-line B. When the foils 5 are arranged in a neutral position on the endless traction member 2a,b, the cord line C is generally parallel with a lengthwise direction of the endless traction members 2a,b. The lengthwise direction of the endless traction members 2a,b is coincident with the travelling direction T. The neutral position may occur when the foil 5 is not affected by any external forces or currents. The neutral position may also be the position of the foil 5 when passing the rotatable stations 3,4.

An asymmetric foil 5 is defined by an upper camber side 35 with a different flow profile than a lower camber side 36. The upper camber side 35 is defined as the side of the chord line C where the camber mean-line B is present or the majority of the camber mean-line B is present. In the illustrated embodiment, the upper camber side 35 is more convex than the lower camber side 36. The upper camber side 35 is therefore provided with a low pressure profile, and the lower camber side 36 is provided with a high pressure profile.

In one embodiment, the foil span S may be approximately 10 meters, the chord line C approximately 50 cm, and a maximum camber of approximately of 2% at 40% chord (for example a NACA 2418 airfoil). The invention shall, however, not be limited to such dimensions.

Each foil 5 is preferably stiff. A stiff structure implies that the foils 5 do not comprise any moving parts that alter the general shape of the foils 5. The cross section of the foil 5, e.g. as illustrated in FIG. 3, is thus permanent, and is not configured to change. The upper and lower camber sides 35,36 are in a stiff, asymmetric foil 5 fixed. A fixed camber side meaning one side of the foil 5 is always the upper camber side 35 (in FIG. 3 the top side), and the reverse side is always the lower camber side 36 (in FIG. 3 the bottom side). Even if the direction of the current is changed or even reversed, the top and bottom side of the foil 5 is always the upper and lower camber side, respectively.

The cross section may change e.g., along the span S of the foil 5, but the stiff characteristic provides a constant physical appearance of the foil 5. The asymmetric shape, the dimensions and the shape of the foils 5 are thus constant. Suitable foil materials may be aluminum, resin, PVC and composites, which are all considered stiff materials, but the foils 5 may also be made from e.g., plastic or fabrics swept around a stiff skeleton. It has been found that stiff, asymmetrical foils 5 are much more efficient in use with underwater power plants than symmetrical foils or foils that are not stiff.

The foils 5 are connected to the endless traction members 2a,b such that the upper camber side 35 is facing in a direction generally outwards O of the at least one endless traction member 2a,b, or generally outwards O towards an area or volume defined on an outside of the endless traction members 2a,b. As the endless traction member 2a,b defines a closed loop, and the foils 5 are arranged on the endless traction member 2a,b, the direction outwards O is thus the direction generally out of this closed loop. The lower camber side 36 is facing in a direction generally inwards I of the at least one endless traction member 2a,b, or generally inwards I towards an area or volume defined on an inside of the endless traction members 2a,b. As the endless traction member 2a,b defines a closed loop, and the foils 5 are arranged on the endless traction member 2a,b, the direction inwards I is thus the direction generally into this closed loop. When the foils 5 are in the neutral position, i.e. not affected by a water current v_{c}, the directions outwards O and inwards I are generally perpendicular to the travelling direction T of the endless traction member 2a,b.

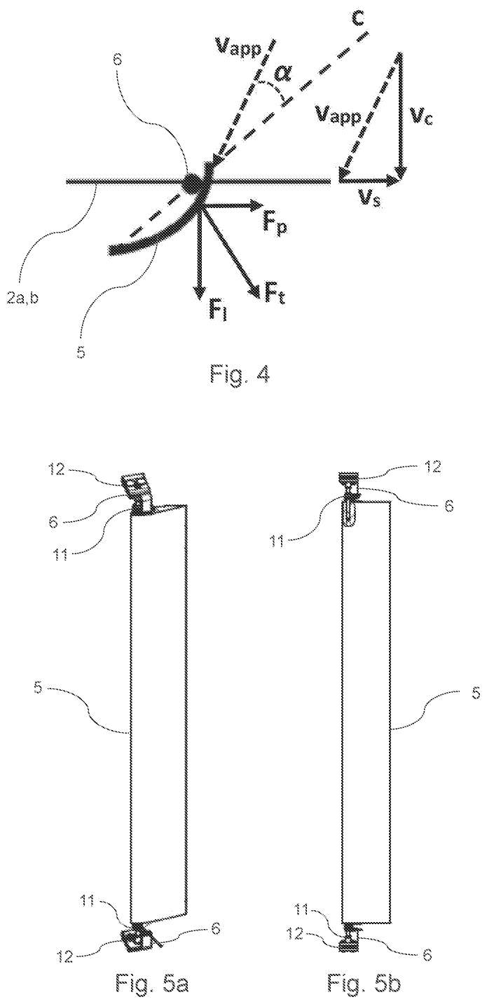

The directions outwards O and inwards I are illustrated in FIG. 1 where the inwards direction is indicated by three arrows I, and the outwards direction is indicated by three arrows O. The chord line C of the foil 5 is in a neutral position aligned with the travelling direction T of the endless traction members 2a,b. When the foil 5 is impacted by a water current, it is angled relative to the travelling direction T of the endless traction members 2a,b, as is described more in detail with reference to FIG. 4.

As the lower camber side 36 of the foils 5 is facing inwards I of the underwater power plant 1, the foils 5 on the downstream leg L_{D} are impacted by the current v_{c} to a greater extent than the foils 5 on the upstream leg L_{U}. The lower camber side 36 (the high pressure side) of the foils 5 on the downstream leg L_{D} are facing, and thus impacted by, the current v_{c}, and the upper camber side 35 (the low pressure side) of the foils 5 on the upstream leg L_{U} are facing, and thus impacted by, the current v_{c}. The effect of this is that the downstream leg L_{D} is forced away from the upstream leg L_{U}, preventing crash between the two legs L_{U},L_{D} and providing smooth operation of the power plant 1. If the current v_{c} increases in strength, the effect of the downstream leg L_{D} pulling away from the upstream leg L_{U} is even more prominent.

Each foil 5 may comprise a connection member 9 for connecting the foil 5 to the endless traction members 2a,b. The connection member 9 may be a shaft, a pin or similar member configured for connecting a foil 5 to an endless traction member 2a,b. The connection member 9 allows the foil 5 to rotate relative to the endless traction members 2a,b about the connection member 9. The connection member 9, or an imaginary line between two connection members 9 arranged at the upper and lower ends of the foil 5, may be positioned such that the area of the foil 5 between the connection member 9 and the trailing edge E_{T} is larger, or configured to be greater impacted by the current v_{c}, than the area between the connection member 9 and the leading edge E_{L}. The foil 5 may as such be configured to maintain its direction relative to the current v_{c}. The connection member 9 may be fixed to the foil 5 and rotatably connected to respective connection devices 6. The upper and lower connection devices 6 are connected to respective upper and lower endless traction members 2a,b (see FIG. 2). FIG. 2 illustrates that the connection member 9, in the form of a shaft, extends through the foil span S, parallel with the foil span S, but the connection member 9 may comprise other rotatable connection means such as individual bolts or pegs.

In FIG. 1, the underwater power plant 1 is shown arranged in water, transversely to a current v_{c}. Referring additionally to FIG. 4, v_{c} denotes the true water velocity, vₐₚₚ is the apparent water velocity, vₛ is the velocity of the foil (and endless traction member), and a is the angle of attack (AoA). The total force F t is the sum of the lateral force, Fₗ, and the propulsive force, Fₚ; the latter acting along the endless traction member 2a,b. In use, therefore, the true water velocity, vₐₚₚ, cause the asymmetric foil to generate the propulsive force, Fₚ; which causes the endless traction members to move in the travelling direction T, and cause the sheaves to rotate in the direction R.

The underwater power plant 1 is configured for rotation in one direction R. The illustrated embodiment of FIG. 1 shows an underwater power plant 1 where the endless traction member 2a is configured for rotation in a direction R against the clock, because of the orientation of the foils 5 on the endless traction members 2a,b. In another embodiment, an underwater power plant may be configured for rotation in a direction with the clock, provided the foils are arranged reversely on the endless traction members.

As indicated in FIG. 1, each foil 5 has a free lateral travel sector β₁, β₂ to either side of the endless traction members 2a,b to which the connection member 9 is connected. This restriction may be defined by a damper element 11 (e.g. spring constant) or other abutment members. In one embodiment, β₁=β₂=10°. In another embodiment, β₁≠β₂.

When the foil 5 is in the neutral position β₁=β₂=0°. Also as indicated in FIG. 1, the upper camber side 35 is facing in an outwards direction O when the foil 5 is positioned anywhere within in the lateral travel sector β₁, β₂. Correspondingly, the lower camber side 36 is facing in an inwards direction I when the foil 5 is positioned anywhere within in the lateral travel sector β₁, β₂.

Referring to FIGS. 5a and 5b, each foil 5 may comprise a connection device 6. In the illustrated embodiment, the foil 5 is connected to two endless traction members, and comprises as such two connection devices 6, an upper connection device 6 and a lower connection device 6. Each connection device 6 is fixedly connected to its respective endless traction member by means of e.g. a clamp 12 or similar fixture. The connection device 6 may comprise a receptacle for the rotatable connection member (illustrated in FIG. 2) such that the foil 5 may rotate about the connection member, as described with reference to FIG. 2. The damper element 11, such as a torsion spring or a coil spring, may restrict rotation of the connection member 9 in the connection device 6 and restore the connection member 9 (and the asymmetric foil 5) to an equilibrium position. The damper element 11 is arranged to restrict the rotation of the foil 5 about an axis parallel with the span S (illustrated in FIG. 2). The damper element 11 may be replaceable and/or adjustable. It should be understood that a similar restriction and restoring device may be embedded in the foil 5.

The clockwise travelling foils 5 of the illustrated embodiment may lean towards their respective damper elements 11 on both upstream (asymmetric/port beam reach leg) and downstream legs (symmetric/starboard beam reach leg) independent of current direction, allowing the upper camber side to face outwards, and facilitating passing of the foil around the rotatable stations throughout their loop travel. The foil's high angle of attack may be maintained until the water current speed v_{c3} exceeds a predetermined threshold of e.g., 1.5 m/s, at which point the damper elements 11 may start compressing a and thus reducing the angle of attack in tune with increase in water current speed. An important peak shaving is thus facilitated in order not to compromise the structural integrity of the plant.

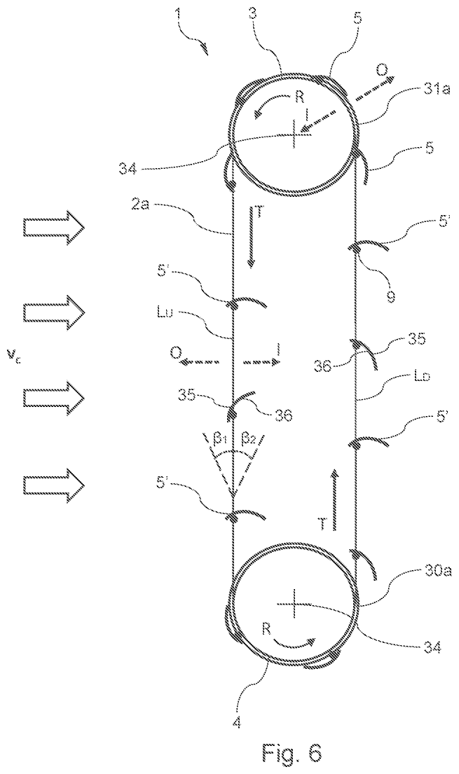

FIG. 6 shows the underwater power plant 1 where some foils 5′ have been released such that they are free to rotate about the connection member 9 relative to the endless traction members 2a,b. The camber lines C (not illustrated in FIG. 6, see FIG. 3) of the foils 5′ may thus be aligned, or generally aligned, with the water current v_{c} or the apparent water velocity vₐₚₚ (as described with reference to FIG. 4), such that the released foils 5′ may not contribute to move the endless traction members 2a,b in the travelling direction T. Such releasing of the foils 5 is advantageous if the allowed travel of the foils 5 at the maximum allowed travel β₁, β₂ to either side is not enough to limit the speed of the endless traction members 2a,b. Releasing the foils 5 may be necessary to prevent excess overload on the power plant 1 if the speed of the water current v_{c} is too high, and e.g. exceeds a threshold.

In FIG. 6, every second foil along the downstream leg L_{U} and the upstream leg L_{D} is released. Any number of released foils 5′ is possible, and e.g., every third foil 5 on the upstream leg L_{D} could in one example be released, while e.g., all or none of the foils 5 on the downstream leg L_{U} could be released. By releasing more foils 5′ on the upstream leg L_{U} than the downstream leg L_{D}, the power plant 1 can be manipulated such that the downstream leg L_{D} is more impacted by the water current v_{c} and thus pulls away from the upstream leg L_{U}.

The foils 5 may be released and connected at the rotatable stations 3,4, such that the number of released foils 5′ may be continuously adjusted, and the number of released foils 5′ may be continuously adapted to the strength of the water current v_{c}. Every foil may as such be configured to be released. A connecting mechanism at the rotatable station 3 may e.g., disconnect the damper element 11, such that the released foil 5′ may rotate freely about the connection member 9. When the released foil 5′ has travelled to the next rotatable station 4, a corresponding connecting mechanism at the rotatable station 4 may connect the damper element 11, such that the foil 5 again is limited to move within the travel sector β₁, β₂. The connecting mechanism may be automatically operated, such that releasing and connecting foils 5′ may be automatic and based on e.g., the water current speed v_{c}. the power output of the generator 33 (not shown in FIG. 6), or similar input.

It will be appreciated that the present disclosure should not be limited to the number of foils. An embodiment of the present disclosure may comprise any number of foils ranging from one foil to a plurality of foils.

The person skilled in the art realizes that the present invention is not limited to the preferred embodiments described above. The person skilled in the art further realizes that modifications and variations are possible within the scope of the appended claims. Additionally, variations to the disclosed embodiments can be understood and effected by the skilled person in practicing the claimed invention, from a study of the drawings, the disclosure, and the appended claims.

Changes and modifications in the specifically-described embodiments may be carried out without departing from the principles of the present invention, which is intended to be limited only by the scope of the appended claims as interpreted according to the principles of patent law including the doctrine of equivalents.

1. An underwater power plant for arrangement in a water current (v_{c}), the underwater power plant comprising:
at least two rotatable stations;
at least one endless traction member connected to the at least two rotatable stations,
wherein the at least one endless traction member is configured to rotate the at least two rotatable stations as the at least one endless traction member moves along a lengthwise direction (T) of the at least one endless traction member;
at least one asymmetric foil connected to the at least one endless traction member and comprising an upper camber side and lower camber side;
wherein the at least one asymmetric foil is configured to move the at least one endless traction member in the lengthwise direction (T) as the water current (v_{c}) impacts the at least one asymmetric foil;
wherein the upper camber side of the at least one asymmetric foil is facing in a direction outwards (O) of the at least one endless traction member and the lower camber side of the at least one asymmetric foil is facing in a direction inwards (I) of the at least one endless traction member;
wherein the power plant is oriented so as to define a downstream leg (L_{D}) and an upstream leg (L_{U}) with respect to the water current (v_{c}) for the at least one traction member; and
wherein the lower camber side on the downstream leg (L_{D}) is facing the water current (v_{c}) and the upper camber side on the upstream leg (L_{U}) is facing the water current (v_{c}).

2. The underwater power plant of claim 1, wherein the upper camber side has a low pressure profile, and wherein the lower camber side has a high pressure profile.

3. The underwater power plant of claim 1, wherein the at least one asymmetric foil is stiff.

4. The underwater power plant of claim 1, wherein the at least one endless traction member comprises a rope or other elongated and flexible member.

5. The underwater power plant of claim 1, wherein the at least one endless traction member is rotatably supported by rotatable sheaves connected to the at least two rotatable stations.

6. The underwater power plant of claim 1, wherein at least one of the two rotatable stations comprises a generator and a rotatable transmission means, and wherein the generator is capable to generate electrical energy when the at least one endless traction member is moving.

7. The underwater power plant of claim 1 further comprising a connection device for rotatably connecting the at least one asymmetric foil to the at least one endless traction member.

8. The underwater power plant of claim 7, wherein the at least one asymmetric foil (5) further comprises a connection member (9) for connecting the at least one asymmetric foil to the connection device.

9. The underwater power plant of claim 8, wherein a damper element is arranged to restrict rotation of the at least one asymmetric foil about an axis that is parallel to a span (S) of the at least one asymmetric foil.

10. The underwater power plant of claim 9, wherein the damper element is a spring.

11. The underwater power plant of claim 9, wherein rotation of the at least one asymmetric foil is restricted by a free lateral travel sector (β1, β2), to either side of the at least one endless traction member.

12. The underwater power plant of claim 9, wherein the at least one asymmetric foil is configured to be released from the damper element at a first rotatable station of the at least two rotatable stations thereby allowing the at least one asymmetric foil to freely rotate about the connection member.

13. The underwater power plant of claim 12, wherein the at least one asymmetric foil is configured to be connected to the damper element at a second rotatable station of the at least two rotatable stations.
